(19) United States
(12) Patent Application Publication
(10) Pub. No.: US 2024/0387157 A1
(43) Pub. Date: Nov. 21, 2024

(54) IMPROVEMENTS IN AND RELATING TO ION ANALYSIS

(71) Applicant: SHIMADZU CORPORATION, Kyoto-shi (JP)

(72) Inventors: Li DING, Ningbo (CN); Aleksandr RUSINOV, Altrincham (GB)

(21) Appl. No.: 18/687,218

(22) PCT Filed: Aug. 27, 2021
(86) PCT No.: PCT/EP2021/073793

§ 371 Date: Feb. 27, 2024

(51) Int. Cl. H01J 49/00

(52) U.S. Cl. CPC H01J 49/0004; H01J 49/0036

(57) ABSTRACT

A method of processing data determined from an image-charge/current signal representative of ions of a given charge state (Q) undergoing oscillatory motion of a respective oscillation frequency (f) within an ion analyser apparatus. A data set comprises a measured signal frequency (f₀) common to a plurality of a measured image-charge/current signals and a plurality of estimated ion charge values corresponding to respective amplitudes of each one of the plurality of measured image-charge/current signals. An integer charge value ([Q]) is generated corresponding to a said estimated ion charge value rounded to the nearest integer value. Using the integer charge value ([Qᵢ]) a plurality of different candidate image-charge/current signal frequency values (f_{Cand}ⁱ) are calculating according to said selected measured signal frequency (f₀) and according to a corresponding one of one or more different candidate charge states of ion (e.g., protonation) and/or of ion isotope or isotopologue. The calculated plurality of different candidate image-charge/current signal frequency values (f_{Cand}ⁱ) are compared to a plurality of different signal frequencies (f) of the measured image-charge/current signals and a score value is calculated representing a degree of similarity therebetween according to the comparison. The charge state (Q) of the ion undergoing oscillatory motion of said selected measured signal frequency (f₀), is then determined to be equal to the integer charge value ([\hat{Q}ₗ,]) if the score value matches or exceeds a threshold score value.

### FIELD OF THE INVENTION

The present invention relates to methods and apparatus for ion analysis using image-charge/current analysis and an ion analyser apparatus therefor. Particularly, although not exclusively, the invention relates to analysis of image-charge/current signals for determining the charge of an ion. For example, image-charge/current signals may be generated by an ion mobility analyser, a charge detection mass spectrometer (CDMS) or an ion trap apparatus such as: an ion cyclotron, an Orbitrap®, an electrostatic linear ion trap (ELIT), a quadrupole ion trap, an Orbital Frequency Analyser (OFA), a Planar Electrostatic Ion Trap (PEIT), or other ion analyser apparatus for generating oscillatory motion therein.

### BACKGROUND

In general, an ion trap mass spectrometer works by trapping ions such that the trapped ions undergo oscillatory motion, e.g. backwards and forwards along a linear path or in looped orbits. An ion trap mass spectrometer may produce a magnetic field, an electrodynamic field or an electrostatic field, or a combination of such fields to trap ions. If ions are trapped using an electrostatic field, the ion trap mass spectrometer is commonly referred to as an “electrostatic” ion trap mass spectrometer.

In general, the frequency of oscillation of trapped ions in an ion trap mass spectrometer is dependent on the mass-to-charge (m/z) ratio of the ions, since ions with large m/z ratios generally take longer to perform an oscillation compared with ions with small m/z ratios. Using an image-charge/current detector, it is possible to obtain, non-destructively, an image charge/current signal representative of trapped ions undergoing oscillatory motion in the time domain. This image-charge/current signal can be converted to the frequency domain e.g. using a Fourier transform (FT). Since the frequency of oscillation of trapped ions is dependent on m/z, an image-charge/current signal in the frequency domain can be viewed as mass spectrum data providing information regarding the m/z distribution of the ions that have been trapped.

In mass spectrometry, one or more ions undergoing oscillatory motion within an ion analyser apparatus (e.g. an ion trap) may induce an image-charge/current signal detectable by sensor electrodes of the apparatus configured for this purpose. A well-established method for analysing such an image-charge/current signal is to perform a transformation of that time-domain signal into the frequency domain. The most popular transformation for this purpose is the Fourier transformation (FT). Fourier transformations decompose a time-domain signal into sinusoidal components, each component having a specific frequency (or period), amplitude and phase. These parameters are related to the frequency (or period), amplitude and phase of periodic components (frequency components) present in the measured image-charge/current signal. The frequency (or period) of those periodic components can be easily related to the m/z value of the respective ion species or to its mass if its charge state is known. In standard mass spectrometry (MS) many ions are typically injected simultaneously into an ion analyser.

After some time, these ions form compact ion packets (clouds) isolated in space. Each cloud corresponds to the same (or very close) mass-to-charge (m/z) value. One can attempt to recover the charge of ions in each ion cloud by means of the positions in the frequency domain of signal peaks and frequency differences between adjacent peaks corresponding to different charge states for a given molecular ion species. However, to do this we must assume that all ions within a cloud have the same charge. This assumption is problematic because it is not always accurate to attribute a charge to a given frequency peak amplitude if one does not know the composition of the ion cloud: e.g., the number of ions it contains; how many of them were lost from the cloud in the course of oscillations etc. In general, the assumption that all ions within a cloud have the same charge is not correct, because there may be other ions within the cloud with the same (or very close) m/z value (e.g., a higher mass M and a higher charge Z). For real experiments with a mixture of many species in a sample this situation is typical. Furthermore, when ion masses become very large (e.g., about 1 MDa and higher) the m/z charge state signal peaks can be difficult to distinguish using existing analysis methods and sometimes cannot be distinguished at all. In addition to this, space charges within ion cloud make things worse, especially if each ion is multiply charged. These space charges quickly smear (spread) the ion cloud in space and the spectral quality of the signals from the ion analyser deteriorates. Knowledge of the true charge state of an ion can prove difficult to measure accurately due to the effects of noise, such as instrumental noise, in the measured image-charge/current signal. This results in reduced accuracy of measurement of the mass value of the respective ion species.

The present invention has been devised in light of the above considerations.

### SUMMARY OF THE INVENTION

Image-charge/current signals may be acquired in mass spectrometers which use non-destructive detection of signals containing periodic components corresponding to oscillations of certain trapped ion species. However, the invention is applicable to any other field ion analysis where signals containing periodic components need to be analysed. The frequency of ion motion depends on its mass-to-charge (m/z) ratio, and where multiple packets of ions exist within an ion analyser (e.g. ion trap), the motion of each packet of ions with the same m/z ratio may be synchronous as provided by the focusing properties of an ion analyser.

Detection of ions using image charges is based on principles derived by Shockley [W. Shockley: “Currents to Conductors Induced by a Moving Point Charge”, Journal of Applied Physics 9, 635 (1938)] and Ramo [S. Ramo: “Currents Induced by Electron Motion”, Proceedings of the IRE, Volume 27, Issue 9, September 1939]. Here, it was shown that a measurable current is induced in an electrode by the image of a moving charge passing by that electrode. The induced image charge, q, on the electrode of a detector device produced by a charge Q moving in free space with a vector of velocity (\vec{v} (r)), depends upon only the location, r, and velocity of the moving charge and the configuration of the electrodes of the detector device. The image charge q is independent of the bias voltages applied to the electrodes, and of any space charge present, and is given by:

$$q = - QV ( r )$$

Here V (r) is the potential of the electrostatic field at the location of the charge given by vector r within the detector apparatus under the following circumstances: the selected electrode in the absence of the charge Q is at unit potential, all other electrodes are at zero potential. The induced image-charge current, I, is given by the rate of change of this quantity as follows:

$$I = \frac{dq}{dt} = - Q \frac{dV ( r )}{dt} = - \frac{dV ( r )}{dr} \cdot \frac{dr}{dt} = Q \vec{E} ( r ) \cdot \vec{v} ( r )$$

Here \vec{E} (r) is an electric field (vector) known as the “weighting field”. As a simple and illustrative example of how this relationship may be implemented, consider a detector apparatus comprising a pair of plane parallel electrode plates separated by a uniform distance d, between which an ion of charge Q moves at speed v₀ in a circular orbit in a plane which is perpendicular to the plane of the two electrode plates. The “weighting field” is uniform and directed perpendicular to the electrode plates and parallel to the ion orbit (practically speaking, this is effectively true if the dimensions of the plates are much larger that the distance between them, so that the fringe effects are negligible). Thus:

$$\vec{E} ( r ) \cdot \vec{v} ( r ) = \frac{{v}_{0}}{d} cos ( ω t + φ )$$

As a result, the induced image-charge/current is a sinusoidal oscillatory signal of the form:

$$I = Q \frac{{v}_{0}}{d} cos ( ω t + φ )$$

The amplitude of the induced image-charge current is proportional to the charge, Q, of the ion. By measuring this amplitude, one may determine the charge on the ion, once the constant of proportionality term v₀/d is taken into account. More generally, the same principle applies to more complex electrode structures of a detector apparatus, in that the amplitude of the induced image-charge/current is proportional to the charge, Q, of the ion, and the constant of proportionality term will differ depending upon the geometry of the electrodes of the detector apparatus.

The invention relates to analysis of image-charge/current signals. For example, in image-charge/current analysis methods one needs to measure the mass-to-charge ratio (m/z) of an ion and its charge (Q) to enable one to estimate the mass of the ion via the relation:

$$m = ( m / z ) Q$$

The frequency of oscillatory ion motion can be determined very precisely, but the accuracy by which ion charge Q may be estimated by direct image-charge/current signal measurement is severely deteriorated by electronic noise within the ion analyser apparatus.

The inventors have realised a process to more accurately determine the charge of an ion based on a procedure of rounding measured (estimated) charge values to an integer number and scoring rounded charge values whereby a proposed charge value is scored using a score calculated based on the presence or absence of contributions to the image-charge/current signal dataset from other ions. A proposed charge value can replace a measured (estimated) charge value if it achieves a sufficiently high score. The number of misassignments of ion charge value may reduce as a result. Correct assignments of ion charges improve resulting mass spectra. One may obtain a higher accuracy mass spectrum using the output of a image-charge/current system with low charge measurement accuracy. Charge measurement accuracy is typically improved in prior art systems by employing complex and expensive optimised components and cryogenic cooling of the detection circuitry of a image-charge/current system. The invention provides a way of achieving improved measured charge accuracy without the need to resort to complex and expensive electronics and/or cryogenics.

In a first aspect, the invention provides a method of processing data determined from an image-charge/current signal representative of ions of a given charge state (Q) undergoing oscillatory motion of a respective oscillation frequency (f) within an ion analyser apparatus, the method comprising:
generating an integer charge value ([Q]) corresponding to a said estimated ion charge value rounded to the nearest integer value; and,
   (a) selecting said integer charge value ([Qᵢ]) and therewith calculating a plurality of different candidate image-charge/current signal frequency values (f_{Cand}ⁱ) according to said selected measured signal frequency (f₀) and according to a corresponding one of one or more different candidate charge states of the ion (e.g., protonation (n), adductions (l)) and/or of ion isotope or isotopologue; then,
   (b) comparing the calculated plurality of different candidate image-charge/current signal frequency values (f_{Cand}ⁱ) to a plurality of different signal frequencies (f) of the measured image-charge/current signals and calculating a score value representing a degree of similarity therebetween according to the comparison;
determining the charge state (Q) of the ion undergoing oscillatory motion of said selected measured signal frequency (f₀), to be equal to the integer charge value ([\hat{Q}ₗ]) if said score value matches or exceeds a threshold score value.

For example, image-charge/current signals may be generated by an ion mobility analyser, a charge detection mass spectrometer (CDMS) or an ion trap apparatus such as: an ion cyclotron, an Orbitrap®, an electrostatic linear ion trap (ELIT), a quadrupole ion trap, an Orbital Frequency Analyser (OFA), a Planar Electrostatic Ion Trap (PEIT), or other ion analyser apparatus for generating oscillatory motion therein.

Desirably, the step of generating an integer charge value ([Q]) comprises generating a plurality of integer charge values ([Q]) each corresponding to a respective said estimated ion charge value rounded to the nearest integer value; and,
(c) repeating step (a) and step (b) in respect of each said integer charge value ([Qᵢ]) amongst said generated integer charge values ([Q]); then,
(d) identifying the integer charge value ([\hat{Q}ₗ]) achieving the highest said score value;
   wherein said threshold score value corresponds to the highest said score value and said charge state (Q) of the ion is determined to be equal to the identified integer charge value ([\hat{Q}ₗ]) achieving the highest said score value.

Consider an ion of mass M₀ undergoing oscillatory motion of frequency f₀ within a image-charge/current type mass analyser device. Imagine that there are Q+n (Q, n=integer) protons bonded to the ion by protonation. These protons add extra mass and charge to the intrinsic mass M₀ and they add a charge (Q+n) e to the ion (e is the charge of a proton) such that the mass-to-charge ratio (m/z) of the composite body (i.e., the ion plus the protons bonded to it) is given by:

$$( \frac{m}{z} ) = ( \frac{{M}_{0} + ( Q + n ) {m}_{p}}{( Q + n ) e} )$$

If the number of protons bonded to the ion by protonation was reduced to Q protons (i.e., n=0), then the mass-to-charge ratio (m/z)₀ of the ion would be given by:

$${( \frac{m}{z} )}_{n = 0} = \frac{{M}_{0} + {Qm}_{p}}{Qe}$$

$$Thus ,$$

$${M}_{0} = ( {( \frac{m}{z} )}_{n = 0} e - {m}_{p} ) Q$$

Therefore, substituting this into the above equation gives:

$${( \frac{m}{z} )}_{n} = {( \frac{m}{z} )}_{n = 0} ( \frac{Q}{Q + n} ) + ( \frac{{m}_{p}}{e} ) ( \frac{n}{Q + n} )$$

A well-known relationship exists between the mass-to-charge ratio (m/z) of an ion undergoing oscillatory motion in a image-charge/current type mass analyser device and its signal frequency, fⱼ:

$${( \frac{m}{z} )}_{i} = {( \frac{α}{{f}_{i}} )}^{2}$$

Here, the term α is a calibration constant that is dependent upon the geometry of the image-charge/current type mass analyser device and the energy of the ion. Therefore, substituting this into the above equation gives:

$${( \frac{α}{{f}_{n}} )}^{2} = {( \frac{α}{{f}_{0}} )}^{2} ( \frac{Q}{Q + n} ) + ( \frac{{m}_{p}}{e} ) ( \frac{n}{Q + n} )$$

Here, the frequency value f₀ is a selected measured signal frequency and corresponds to the situation where the number of protons bonded to the ion by protonation is Q protons (i.e., n=0). Indeed, when n=0, the above expression simply reduces to:

$${( \frac{α}{{f}_{n}} )}^{2} = {( \frac{α}{{f}_{0}} )}^{2}$$

However, if n≠0, then the above equation predicts that there should exist additional frequency components within the image-charge/current measured signal which are positioned at the following frequencies:

$${f}_{n} = α \times {[ {( \frac{α}{{f}_{0}} )}^{2} ( \frac{Q}{Q + n} ) + ( \frac{{m}_{p}}{e} ) ( \frac{n}{Q + n} ) ]}^{- 1 / 2} ; n = integer$$

The inventors have realised this relationship and that by making a series of predictions for different values of these additional frequency components, by selecting different values of the integer n, one may compare the predicted additional frequency positions to the positions of actual frequency components within the measured image-charge/current signal. If this comparison shows a sufficiently good degree of similarity as between predicted and measured frequency positions of frequency components, then one may conclude that the value of Q is an accurate prediction of the true value of the charge state of an ion.

Accordingly, preferably, the calculating of a plurality of different candidate image-charge/current signal frequency values (f_{Cand}ⁱ) is performed to satisfy the following condition:

$${( \frac{α}{{f}_{Cand}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n}{[ {Q}_{i} ] + n} )$$

where n is an integer selected to quantify a number of protonating protons bonded to the ion, mₚ is the mass of a proton (which is assumed to equal the mass of the neutron), e is the charge of a proton, and α is a pre-set calibration constant. The value of n may be selected, as desired, to be any integer value and any desired number of different values of n may be selected to generate corresponding number of different candidate frequency values f_{Cand}ⁱ according to this expression. In other words, [Qᵢ]+n may represent a given protonation state, or total number of protonating protons, and different values of n may represent different protonation states: thus, for a given value [Qᵢ], the integer n may define a difference in the number of protonating protons as between two different protonation states.

Preferably, as a generalisation of this, the calculating of a plurality of different candidate image-charge/current signal frequency values (f_{Cand}ⁱ) is performed to satisfy the following condition:

$${( \frac{α}{{f}_{Cand}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k}{[ {Q}_{i} ] + n} )$$

where n is an integer selected to quantify a number of protonating protons bonded to the ion, k is an integer selected to quantify a difference in a number of nuclear neutrons as between different isotopes or isotopologues of the ion, mₚ is the mass of a proton (which is assumed to equal the mass of the neutron), e is the charge of a proton, and α is a pre-set calibration constant. The value of n and k may be selected, as desired, to be any integer value and any desired number of different values of n and k may be selected to generate corresponding number of different candidate frequency values f_{Cand}ⁱ according to this expression. As mentioned above, [Qᵢ]+n may represent a given protonation state, or total number of protonating protons, and different values of n may represent different protonation states: thus, for a given value [Qᵢ], the integer n may define a difference in the number of protonating protons as between two different protonation states.

The term ‘isotope’ herein may be understood to include a reference to any one of two or more forms of an element where the atoms have the same number of protons, but a different number of neutrons within their nuclei as a consequence, atoms for the same isotope will have the same atomic number but a different mass number (atomic weight). The term ‘isotopologue’ herein may be understood to include a reference to any one of two or more forms of a compound only differing in their isotopic composition; for example water and heavy water.

Desirably, as a further generalisation, the calculating of a plurality of different candidate image-charge/current signal frequency values (f_{Cand}ⁱ) is performed to satisfy the following condition:

$${( \frac{α}{{f}_{C a n d}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k ∓ l}{[ {Q}_{i} ] + n} ) \pm ( \frac{{m}_{X}}{e} ) ( \frac{l}{[ {Q}_{i} ] + n} )$$

where l is an integer selected to quantify a number of adduct ions of mass mₓ bonded to the ion. The value of n, k and l may be selected, as desired, to be any integer value and any desired number of different values of n, k and l may be selected to generate corresponding number of different candidate frequency values f_{Cand}ⁱ according to this expression. For the avoidance of doubt, [Qᵢ]+n may represent a given protonation state, or total number of protonating protons, and different values of n may represent different protonation states: thus, for a given value [Qᵢ], the integer n may define a difference in the number of protonating protons as between two different protonation states.

The step of acquiring a data set may comprise selecting a measured signal frequency (f₀) common to said plurality of a measured image-charge/current signals and, calculating said plurality of estimated ion charge values according to the measured respective amplitudes of each one of said plurality of measured image-charge/current signals.

The degree of similarity may comprise a sum of the number of calculated candidate image-charge/current signal frequency values (f_{Cand}ⁱ) that differ from a signal frequency amongst said plurality of a measured image-charge/current signals, by less than a predetermined threshold difference value. The degree of similarity between candidate frequencies (f_{Cand}ⁱ) and measured frequencies (fⱼ), amongst the plurality of a measured image-charge/current signals, may comprise a sum (S_{Cand}ⁱ) of the number of candidate signal frequency values (f_{Cand}ⁱ) that differ from a signal frequency (fⱼ; j=0, 1, . . . N−1), by less than a predetermined threshold difference value (ε). For example, the degree of similarity may simply count the number of candidate frequencies that satisfy the following condition:

$${Δ}_{Cand}^{i , j} = \vert {f}_{j} - {f}_{C a n d}^{i} \vert \leq ε , j = 0 , 1 , … N - 1$$

The predetermined threshold difference value (ε) may be set by the user. The predetermined threshold difference value (ε) may be set to be substantially equal to the pre-determined, or pre-measured, uncertainty range or standard-deviation/variance in the measurements (fⱼ; j=0, 1, . . . N−1) of the image-charge/current signal frequency components. The method may comprise determining the charge of the ion to be the integer charge value ([\hat{Q}ₗ]) that achieves a score value that matches or exceeds a threshold score value (S_{Thresold}):

S_{Cand}ⁱ≥S_{Thresold}

Alternatively, the degree of similarity may comprise a sum of the differences between each calculated candidate image-charge/current signal frequency value (f_{Cand}ⁱ) and a signal frequency nearest thereto from amongst said plurality of a measured image-charge/current signals. The score value may be inversely proportional to said sum of differences.

The calculating of a plurality of different candidate image-charge/current signal frequency values (f_{Cand}ⁱ) may comprise selecting a plurality of different candidate states of ion isotope or isotopologue (k) each of which shares a common fixed candidate state of ion protonation (n).

The calculating of a plurality of different candidate image-charge/current signal frequency values (f_{Cand}ⁱ) may comprise selecting a plurality of different candidate charge states of the ion (e.g., ion protonation (n), adduct ions (l)) each of which shares a common fixed candidate state of ion isotope or isotopologue (k).

The calculating a plurality of different candidate image-charge/current signal frequency values (f_{Cand}ⁱ) may comprise selecting different candidate charge states of the ion (e.g., protonation (n), adduct ions (l)) and simultaneously different candidate states of ion isotope or isotopologue (k).

The method may comprise determining a mass value (M) for the ion undergoing oscillatory motion of said selected measured signal frequency (f₀), according to the identified integer charge value ([\hat{Q}ₗ]) achieving the highest said score value and according to the relation:

$$M = [ {\hat{Q}}_{ι} ] {( \frac{α}{{f}_{0}} )}^{2}$$

It is to be understood that the methods described above may be implemented in an apparatus configured to implement these methods. For example, the apparatus may comprise a processor or computer. The methods may be implemented by the apparatus by applying the methods to data generated by a separate ion analyser apparatus separate and subsequently acquired (i.e., not ‘live’ data contemporaneous with generation of the data). Alternatively, of in addition, the methods may be implemented by the apparatus comprising in an ion analyser apparatus comprising such a processor or computer.

In a second aspect, the invention may comprise an apparatus configured to process data determined from an image-charge/current signal representative of ions of a given charge state (Q) undergoing oscillatory motion of a respective oscillation frequency (f) within an ion analyser apparatus, comprising a processor module configured to:
acquire a data set comprising a measured signal frequency (f₀) common to a plurality of a measured image-charge/current signals and a plurality of estimated ion charge values corresponding to respective amplitudes of each one of said plurality of measured image-charge/current signals;
generate an integer charge value ([Q]) corresponding to a said estimated ion charge value rounded to the nearest integer value; and,
   (a) select said integer charge value ([Qᵢ]) and therewith calculate a plurality of different candidate image-charge/current signal frequency values (f_{Cand}ⁱ) according to said selected measured signal frequency (f₀) and according to a corresponding one of one or more different candidate charge states of the ion (e.g., protonation (n), adduct ions (l)) and/or of ion isotope or isotopologue (k); then,
   (b) compare the calculated plurality of different candidate image-charge/current signal frequency values (f_{Cand}ⁱ) to a plurality of different signal frequencies (f) of the measured image-charge/current signals and calculate a score value representing a degree of similarity therebetween according to the comparison;
determine the charge state (Q) of the ion undergoing oscillatory motion of said selected measured signal frequency (f₀), to be equal to the identified integer charge value ([\hat{Q}ₗ]) if said score value matches or exceeds a threshold score value.

Preferably, the processor module is configured to generate an integer charge value ([Q]) by generating a plurality of integer charge values ([Q]) each corresponding to a respective said estimated ion charge value rounded to the nearest integer value; and,
(e) repeat step (a) and step (b) in respect of each said integer charge value ([Qᵢ]) amongst said generated integer charge values ([Q]); then,
(f) identify the integer charge value ([\hat{Q}ₗ]) achieving the highest said score value;
   wherein said threshold score value corresponds to the highest said score value and said charge state (Q) of the ion is determined to be equal to the identified integer charge value ([\hat{Q}ₗ]) achieving the highest said score value.

Desirably, the processor module is configured to calculate said plurality of different candidate image-charge/current signal frequency values (f_{Cand}ⁱ) to satisfy the following condition:

$${( \frac{α}{{f}_{C a n d}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n}{[ {Q}_{i} ] + n} )$$

where n is an integer selected to quantify a number of protonating protons bonded to the ion, mₚ is the mass of a proton (which is assumed to equal the mass of the neutron), e is the charge of a proton, and α is a pre-set calibration constant. The value of n may be selected, as desired, to be any integer value and any desired number of different values of n may be selected to generate corresponding number of different candidate frequency values f_{Cand}ⁱ according to this expression.

Desirably, as a generalisation of the above condition, the processor module is configured to calculate said plurality of different candidate image-charge/current signal frequency values (f_{Cand}ⁱ) to satisfy the following condition:

$${( \frac{α}{{f}_{C a n d}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k}{[ {Q}_{i} ] + n} )$$

where n is an integer selected to quantify a number of protonating protons bonded to the ion, k is an integer selected to quantify a difference in a number of nuclear protons as between different isotopes or isotopologues of the ion, mₚ is the mass of a proton (assumed mass of the neutron), e is the charge of a proton, and α is a pre-set calibration constant. The value of n and k may be selected, as desired, to be any integer value and any desired number of different values of n and k may be selected to generate corresponding number of different candidate frequency values f_{Cand}ⁱ according to this expression.

Desirably, as a further generalisation of the above condition, the processor module is configured to calculate said plurality of different candidate image-charge/current signal frequency values (f_{Cand}ⁱ) to satisfy the following condition:

$${( \frac{α}{{f}_{C a n d}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k ∓ l}{[ {Q}_{i} ] + n} ) \pm ( \frac{{m}_{X}}{e} ) ( \frac{l}{[ {Q}_{i} ] + n} )$$

where l is an integer selected to quantify a number of adduct ions of mass mₓ bonded to the ion. The value of n, k and l may be selected, as desired, to be any integer value and any desired number of different values of n, k and l may be selected to generate corresponding number of different candidate frequency values f_{Cand}ⁱ according to this expression.

The processor module may be configured to acquire said data set by selecting a measured signal frequency (f₀) common to said plurality of a measured image-charge/current signals, and calculating said plurality of estimated ion charge values according to the measured respective amplitudes of each one of said plurality of measured image-charge/current signals.

The processor module may be configured to calculate the degree of similarity as comprising a sum of the number of calculated candidate image-charge/current signal frequency values (f_{Cand}ⁱ) that differ from a signal frequency amongst said plurality of a measured image-charge/current signals, by less than a predetermined threshold difference value. The degree of similarity between candidate frequencies (f_{Cand}ⁱ) and measured frequencies (fⱼ), amongst the plurality of a measured image-charge/current signals, may comprise a sum (S_{Cand}ⁱ) of the number of candidate signal frequency values (f_{Cand}ⁱ) that differ from a signal frequency (fⱼ; j=0,1, . . . N−1), by less than a predetermined threshold difference value (ε). For example, the degree of similarity may simply count the number of candidate frequencies that satisfy the following condition:

$${Δ}_{C a n d}^{i , j} = \vert {f}_{j} - {f}_{C a n d}^{i} \vert \leq ε , j = 0 , 1 , … N - 1$$

The predetermined threshold difference value (ε) may be set by the user. The predetermined threshold difference value (ε) may be set to be substantially equal to the pre-determined, or pre-measured, uncertainty range or standard-deviation/variance in the measurements (fⱼ; j=0, 1, . . . N−1) of the image-charge/current signal frequency components. The processor module may be configured to determine the charge of the ion to be the integer charge value ([\hat{Q}ₗ]) that achieves a score value that matches or exceeds a threshold score value (S_{Thresold}):

S_{Cand}ⁱ≥S_{Thresold}

The processor module may be configured to calculate said degree of similarity to comprise a sum of the differences between each calculated candidate image-charge/current signal frequency value (f_{Cand}ⁱ) and a signal frequency nearest thereto from amongst said plurality of a measured image-charge/current signals, wherein said score value is inversely proportional to said sum of differences.

The processor module may be configured to calculate said degree of similarity to comprise a sum of the number of calculated candidate image-charge/current signal frequency values (f_{Cand}ⁱ) that differ from a signal frequency amongst said plurality of a measured image-charge/current signals, by less than a predetermined threshold difference value.

Desirably, the processor module is configured to calculate said plurality of different candidate image-charge/current signal frequency values (f_{Cand}ⁱ) by a process comprising selecting a plurality of different candidate states of ion isotope or isotopologue (k) each of which shares a common fixed candidate state of ion protonation (n).

Preferably, the processor module is configured to calculate said plurality of different candidate image-charge/current signal frequency values (f_{Cand}ⁱ) by a process comprising selecting a plurality of different candidate charge states of the ion (e.g., ion protonation (n), adduct ions (l)) each of which shares a common fixed candidate state of ion isotope or isotopologue (k).

Desirably, the processor module is configured to calculate said plurality of different candidate image-charge/current signal frequency values (f_{Cand}ⁱ) by a process comprising selecting different candidate charge states of the ion (e.g., protonation (n), adductions (l)) and simultaneously different candidate states of ion isotope or isotopologue (k).

In a third aspect, the invention may provide an ion analyser comprising the apparatus described above.

In a fourth aspect, the invention may provide a computer program or a computer program product adapted to perform the method described above.

In a fifth aspect, the invention may provide a computer-readable storage medium or data carrier comprising the computer program or computer program product described above.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1a shows a schematic representation of a CDMS ion analyser apparatus.

FIG. 1b shows a schematic representation of a CDMS image-charge/current signal generated by the CDMS ion analyser apparatus of FIG. 1a.

FIG. 1c shows a typical CDMS image-charge/current signal output generated by the CDMS ion analyser apparatus of FIG. 1a and comprising a plurality of concurrent CDMS image-charge/current signals of FIG. 1b.

FIG. 2a shows a graph of a plurality of differing estimated charge values [Q] calculated using the concurrent CDMS image-charge/current signals of FIG. 1c of corresponding differing signal amplitudes at each of nine different signal frequency values.

FIG. 2b shows a flow chart of steps in a process for determining an integer charge value for an ion undergoing oscillatory motion of a given frequency selected from the different signal frequency values and the corresponding plurality of differing estimated charge values [Q] of FIG. 2a.

FIG. 3a shows a simulated distribution histogram of isotopic mass deviation in the mass of an ion accounting for range of possible isotopes or isotopologues thereof.

FIG. 3b shows a simulated distribution histogram of charge states [Q] of an ion accounting for range of possible states of protonation thereof.

FIG. 4 shows a simulated distribution histogram of estimated charge states [Q] of an ion generated according to ions having the simulated distribution of isotopic mass deviation shown in FIG. 3a and the simulated distribution of charge states [Q] of FIG. 3b.

FIGS. 5a, 5b and 5c show simulated distribution histograms of estimated mass values for an ion generated according to ions having the simulated distribution of estimated charge states [Q] of FIG. 4 both with and without applying the process of rounding of non-integer estimated charge states [Q] to the nearest integer value.

FIGS. 6a and 6b show simulated distribution histograms of estimated mass values for an ion of FIG. 5a after applying a process according to an embodiment of the invention.

FIGS. 7a and 7b show a measured mass distribution histogram for myoglobin after applying a process according to an embodiment of the invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

In the drawings, like items are assigned like reference symbols, for consistency. In the following example, image-charge/current signals are generated by a real or simulated charge detection mass spectrometer (CDMS) and are referred to as CDMS image-charge/current signals. However, it is to be understood that the image-charge/current signals may alternatively be generated by an ion mobility analyser, or an ion trap apparatus such as: an ion cyclotron, an Orbitrap®, an electrostatic linear ion trap (ELIT), a quadrupole ion trap, an Orbital Frequency Analyser (OFA), a Planar Electrostatic Ion Trap (PEIT), or other ion analyser apparatus for generating oscillatory motion therein.

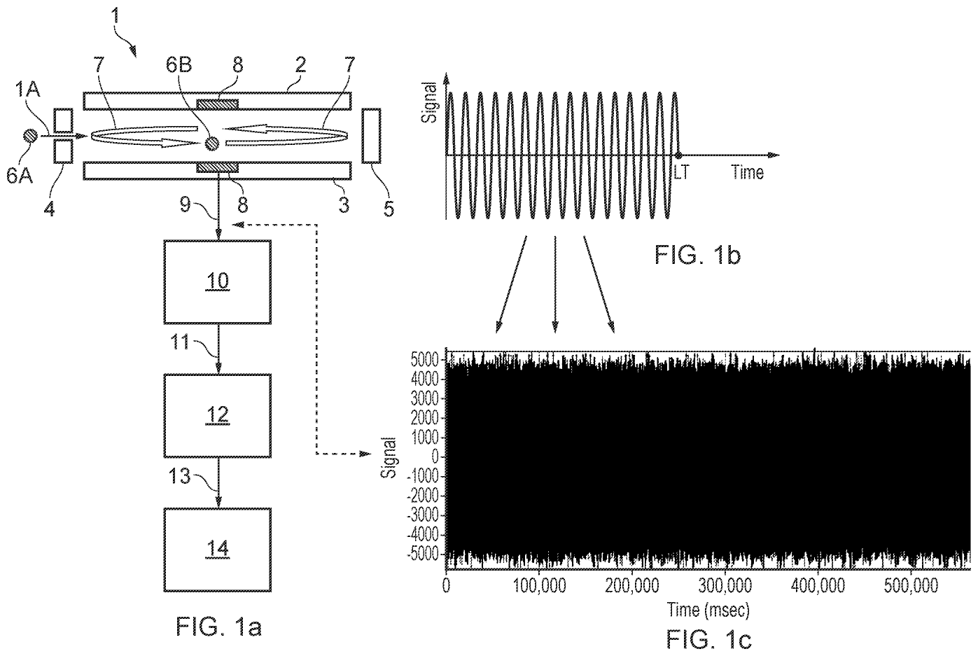

FIG. 1a shows a schematic representation of a CDMS ion analyser apparatus in the form of an electrostatic ion trap 1 for mass analysis. The electrostatic ion trap includes an ion analysis chamber (2, 3, 4, 5) configured for receiving one or more ions 6A and for generating an image charge/current signal in response to oscillatory motion 7 of the received ions 6B when within the ion analysis chamber. The ion analysis chamber comprises a first array of electrodes 2 and a second array of electrodes 3, spaced from the first array of electrodes by a substantially constant separation distance.

A voltage supply unit (not shown) is arranged to supply voltages, in use, to electrodes of the first and second arrays of electrodes to create an electrostatic field in the space between the electrode arrays. The electrodes of the first array and the electrodes of the second array are supplied, from the voltage supply unit, with substantially the same pattern of voltage, whereby the distribution of electrical potential in the space between the first and second electrode arrays (2, 3) is such as to reflect ions 6B in a flight direction 7 causing them to undergo periodic, oscillatory motion in that space. The electrostatic ion trap 1 may be configured, for example, as is described in WO2012/116765 (A1) (Ding et al.), the entirety of which is incorporated herein by reference. Other arrangements are possible, as will be readily appreciated by the skilled person.

The periodic, oscillatory motion of ions 6B within the space between the first and second arrays of electrodes may be arranged, by application of appropriate voltages to the first and second arrays of electrodes, to be focused substantially mid-way between the first and second electrode arrays for example, as is described in WO2012/116765 (A1) (Ding et al.). Other arrangements are possible, as will be readily appreciated by the skilled person.

One or more electrodes of each of the first and second arrays of electrodes, are configured as image-charge/current sensing electrodes 8 and, as such, are connected to a signal recording unit 10 which is configured for receiving an image-charge/current signal 9 from the sensing electrodes, and for recording the received image charge/current signal in the time domain. The signal recording unit 10 may comprise amplifier circuitry as appropriate for detection of an image-charge/current having periodic/frequency components related to the mass-to-charge ratio of the ions 6B undergoing said periodic oscillatory motion 7 in the space between the first and second arrays of electrodes (2, 3).

The first and second arrays of electrodes may comprise, for example, planar arrays formed by:
(a) parallel strip electrodes; and/or,
(b) concentric, circular, or part-circular electrically conductive rings,
   as is described in WO2012/116765 (A1) (Ding et al.). Other arrangements are possible, as will be readily appreciated by the skilled person. Each array of the first and second arrays of electrodes extends in a direction of the periodic oscillatory motion 7 of the ion(s) 6B. The ion analysis chamber comprises a main part defined by the first and second arrays of electrodes and the space between them, and two end electrodes (4, 5). A voltage difference applied between the main segment and the respective end segments creates a potential barrier for reflecting ions 6B in the oscillatory motion direction 7, thereby to trap the ions within the space between the first and second arrays of electrodes. The electrostatic ion trap may include an ion source (not shown, e.g. an ion trap) configured for temporarily storing ions 6A externally from the ion analysis chamber, and then injecting stored ions 1A into the space between the first and second arrays of electrodes, via an ion injection aperture formed in one 4 of the two end electrodes (4, 5). For example, the ion source may include a pulser (not shown) for injecting ions into the space between the first and second arrays of electrodes, as is described in WO2012/116765 (A1) (Ding et al.). Other arrangements are possible, as will be readily appreciated by the skilled person.

The ion analyser 1 further incudes a signal processing unit 12 configured for receiving a recorded image-charge/current signal 11 from the signal recording unit 10, and for processing the recorded signal to determine an amplitude, or magnitude, of the time-domain signal and therewith calculate the charge of an ion undergoing oscillatory motion within the ion analyser apparatus. The signal processing unit 12 also determines a frequency of the oscillatory motion of the ion within the ion analyser apparatus.

The time-domain amplitude value representative of the charge of the target ion may be, for example, an amplitude value derived using a pre-calibrated proportionality relationship between the amplitude value and the corresponding ion charge, Q, in terms of the “weighting field” as described above. These signal processing steps are implemented by the signal processing unit 12 and will be described in more detail below. The signal processing unit 12 comprises a processor or computer programmed to execute computer program instructions to perform the above signal processing steps upon image charge/current signals representative of trapped ions undergoing oscillatory motion. The result is a value representative of the charge of the ion and/or a mass value representative of the mass of the ion. The ion analyser 1 further incudes a memory unit and/or display unit 14 configured to receive data 13 corresponding to the charge on the ion, and to display the determined charge value and/or mass value to a user and/or store that value in a memory unit.

As shown in FIG. 1c, the image-charge/current signal 9 comprises a multitude of concurrent oscillatory signals in the time domain. Each one of the concurrent oscillatory signals within this image-charge/current signal 9 comprises a single oscillatory signal, such as schematically shown in FIG. 1b, which exists for a finite ‘lifetime’ (LT) with a substantially constant signal amplitude and a substantially constant signal frequency (f). Because the apparatus 1, when in use, typically contains many ions of different masses and charge states, all undergoing their own oscillatory motion simultaneously, the image-charge/current signal 9 comprises a multitude of respective concurrent oscillatory signals, each of the form shown in FIG. 1b, but each having a different respective signal amplitude and signal frequency.

The signal processing unit 12 is configured to process the image-charge/current signal (FIG. 1c) to generate estimated values of the charge states (Q) of ions undergoing oscillatory motion of a respective oscillation frequency (f) within the ion analyser apparatus. For example, the induced image-charge/current may be a sinusoidal oscillatory signal of the form:

$$I = QA cos ( ωt + φ )$$

The amplitude, QA where A is a calibration constant, of the induced image-charge current is proportional to the charge, Q, of the ion and thus the charge, Q, of an ion may be estimated using the amplitude, QA, and the frequency, ω, of the component (FIG. 1b) of the overall signal (FIG. 1c) associated with the ion in question. The amplitude, QA, and the frequency, f₀=ω/2π, of the component (FIG. 1b) of the overall signal may be obtained using methods readily known and available to the skilled person in the art. As an example, by application of a Fourier transform to the overall spectrum one may obtain the amplitude, QA, and the frequency, f₀=ω/2π, from the relevant spectral component of the Fourier spectrum of the overall signal.

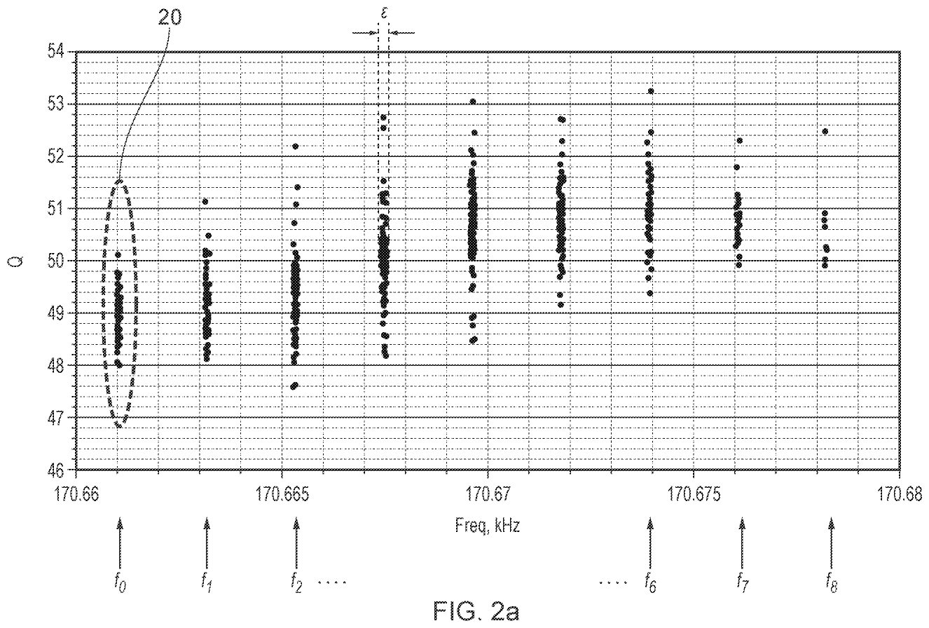

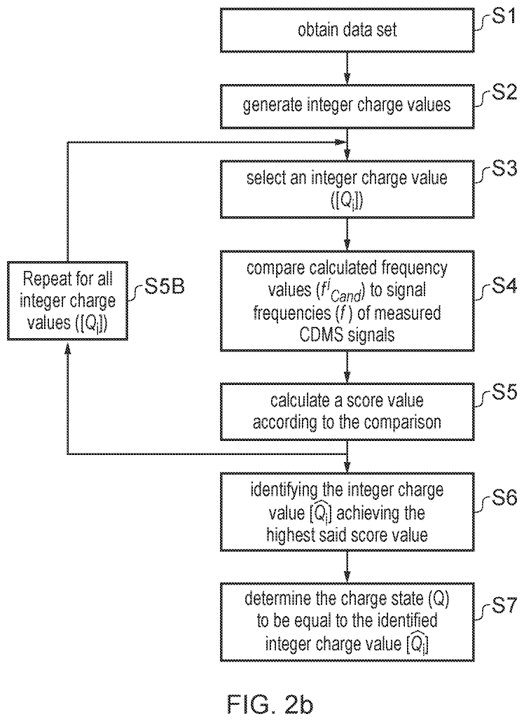

The signal processing unit 12 is configured to acquire a data set (20, FIG. 2a) comprising a measured signal frequency (f₀=170.661 kHz) common to a plurality of a measured CDMS image-charge/current signals (FIG. 1a), and a plurality of estimated ion charge values Q corresponding to respective amplitudes of each one of the plurality of measured CDMS image-charge/current signals. This acquisition may be achieved by applying known CDMS image-charge/current signal processing techniques, readily available to the skilled person, to the overall spectrum to obtain the amplitude, QA, and the frequency, f₀=ω/2π, from the relevant frequency component of the overall signal.

The signal processing unit 12 is configured to generate an integer charge value ([Q]) corresponding to the estimated ion charge value, Q, rounded to the nearest integer value. In particular, each one of the plurality of separate estimated charge values of the set 20 of estimated charges associated with the measured signal frequency (f₀=170.661 kHz), has a non-integer value derived from the non-integer value of the amplitude of the induced image-charge current, QA, where A is a non-integer calibration constant. Because it is known that the true value of the charge of the ion must be an integer multiple of the unit charge e of the electron (or of the proton), then one may assert that the true charge state of the ion is one of the following integers:

[Q]±n

Here, the incrementing integer n may take any one or more of the values: n=0, ±1, ±2, ±3, ±4, ±5, . . . For example, if the true charge state of the ion was [Q]_{TRUE}=49, and the data set 20 comprised ten different non-integer values of estimated ion charge state Q, then the corresponding rounded values [Q] of the charge state and values incrementing integer would be as follows:

| Estimated ion | Rounded ion | |
|---|---|---|
| charge value, Q | charge value, [Q] | Integer n |
| 48.01 | 48 | −1 |
| 48.23 | 48 | −1 |
| 48.32 | 48 | −1 |
| 48.56 | 49 | 0 |
| 48.55 | 49 | 0 |
| 48.71 | 49 | 0 |
| 49.11 | 49 | 0 |
| 49.45 | 49 | 0 |
| 49.50 | 50 | 1 |
| 49.88 | 50 | 1 |

In this way, the set of ten estimated (measured) ion charge state values is reduced to a set comprising three possible integer candidate values: [Q]=48; [Q]=49; [Q]=50. These correspond with the three values of the incrementing integer n=0, ±1. In other examples, there may be only one corresponding value of the incrementing integer n at the end of this rounding process. Of course, whether or not this is the case, and indeed how many different values of the incrementing integer are used, will depend upon the spread of the values of the estimated (measured) ion charge values, Q. The choice of the values of the incrementing integer n may be set according to the user, or may be pre-set within the signal processing unit 12. For example, the choice n=−2, −1, 0 would achieve the same rounded ion charge values if the true charge state of the ion was [Q]_{TRUE}=50. Of course, it is the true charge state of the ion that is to be determined, and the signal processing unit 12 is configured to make an improved prediction of that true value by a process of elimination involving making one or more selections ([Qᵢ]) of a rounded charge value from amongst the rounded charge values it has generated, and determining whether or not the selection(s) conform to a predetermined criterion indicating that that selection is indeed an improvement upon the estimated (measured) values for the ion charge state.

To this end, the signal processing unit 12 then selects one integer charge value ([Qᵢ]) and therewith calculates a plurality of different candidate CDMS image-charge/current signal frequency values (f_{Cand}ⁱ) according to the selected measured signal frequency (f₀) and according to a corresponding one of one or more different candidate states of ion protonation (n) In other words, it is assumed that the different values of the incrementing integer n correspond with different amounts of protonation of the ion (i.e., different numbers of protons attached t the ion). The different numbers of protons potentially attached to the ion has the effect of changing not only the charge state of the protonated ion (in integer multiples of the proton charge), but also has the effect of changing the mass of the protonated ion (according to the mass of the proton(s)). The processor module is configured to calculate a plurality of different candidate CDMS image-charge/current signal frequency values (f_{Cand}ⁱ) to satisfy the following expression:

$${( \frac{α}{{f}_{C a n d}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n}{[ {Q}_{i} ] + n} )$$

where n is an integer selected to quantify a number of protonating protons bonded to the ion, mₚ is the mass of a proton, e is the charge of a proton, and α is a pre-set calibration constant. For example, the incrementing integer n may take any one or more of the values: n=0, ±1, ±2, ±3, ±4, ±5, . . . Each different candidate CDMS image-charge/current signal frequency values (f_{Cand}ⁱ) corresponds to a different respective value of the integer n, for a given selected value of integer charge value ([Qᵢ]). This expression is a generalisation of a well-known relationship between the mass-to-charge ratio (m/z) and the oscillation frequency (f) of an ion undergoing oscillatory motion within an ion analyser apparatus, which is:

$$\frac{m}{z} = {( \frac{α}{{f}_{0}} )}^{2}$$

One can see that the generalised expression reduces to the known expression when n=0. The inventors have realised that the addition of protons (protonation) to the ion will result in additional signal frequencies arising within the overall image-charge/current signal (FIG. 1c) due to the attendant addition of mass and charge to the ion. These additional signal frequencies will appear as frequency components within the frequency spectrum of the overall image-charge/current signal at specific frequencies determined by the possible values of:

$${( \frac{α}{{f}_{0}} )}^{2} ( \frac{{[ Q ]}_{TRUE}}{{[ Q ]}_{T R U E} + n} ) + ( \frac{{m}_{p}}{e} ) ( \frac{n}{{[ Q ]}_{T R U E} + n} )$$

These possible values are, in turn, determined by the correct choice of [Qᵢ]=[\hat{Q}ₗ], such that [\hat{Q}ₗ]=[Q]_{TRUE}, and the correct choice of value(s) for the incrementing integer n. If the correct choices for these quantities are not made, then the different candidate CDMS image-charge/current signal frequency values (f_{Cand}ⁱ) will not correspond to the additional signal frequencies that actually do appear as frequency components within the frequency spectrum of the overall image-charge/current signal. In other words, if a comparison of the different candidate CDMS image-charge/current signal frequency values (f_{Cand}ⁱ) shows that they match, or sufficiently closely approximate, a pattern of signal frequencies within the frequency spectrum of the overall image-charge/current signal, then they may be assumed to represent true additional signal frequencies within the frequency spectrum of the overall image-charge/current signal. Consequently, the selected integer value of the charge state of the ion that satisfies this close match is deemed to be the true charge state: [\hat{Q}ₗ]=[Q]_{TRUE}

To this end, the signal processing unit 12 compares the calculated plurality of different candidate CDMS image-charge/current signal frequency values (f_{Cand}ⁱ) to a plurality of different signal frequencies (f) of the measured CDMS image-charge/current signals and calculates a score value representing a degree of similarity therebetween according to the comparison. The signal processing unit 12 determines that the true charge state (Q) of the ion undergoing oscillatory motion at the selected measured signal frequency (f₀=170.661 kHz₀), to be equal to the identified integer charge value ([\hat{Q}ᵢ]) if the score value matches or exceeds a threshold score value. The threshold score value may be a pre-set score value determined by the user. For example, the signal processing unit 12 may select one integer charge value ([Qᵢ]) in turn and perform the above calculations to determine whether that one integer charge value provides a score value that matches or exceeds a threshold score value and, if it does not, then proceed to select an alternative integer charge value ([Qᵢ]), and repeat the process. The process may be repeated until a pre-set number of different alternative integer charge value ([Qᵢ]) have been selected and considered in this way, or until a selected alternative integer charge value ([Qᵢ]) achieves a score value that matches or exceeds a threshold score value (e.g., whichever occurs first).

Alternatively, the signal processing unit 12 may select a plurality of alternative integer charge values ([Qᵢ]) and generate a corresponding plurality of threshold score values, one for each selected integer charge values ([Qᵢ]). The signal processing unit 12 may dynamically set the threshold score value to be simply the score value of the highest score amongst the corresponding plurality of score values. In this way, highest score value will always be accepted as matching the threshold score value. For example, the processor module may be configured to generate an integer charge value ([Q]) multiple times by generating a plurality of integer charge values ([Q]) each corresponding to a respective estimated ion charge value rounded to the nearest integer value, and in respect of each individual integer charge value ([Qᵢ]) amongst the generated integer charge values ([Q]), and to repeat the steps of:
selecting an integer charge value ([Qᵢ]) and therewith calculating a plurality of different candidate CDMS image-charge/current signal frequency values (f_{Cand}ⁱ) according to the selected measured signal frequency (f₀) and according to a corresponding one of one or more different candidate states of ion protonation (n); then,.
comparing the calculated plurality of different candidate CDMS image-charge/current signal frequency values (f_{Cand}ⁱ) to a plurality of different signal frequencies (f) of the measured CDMS image-charge/current signals and calculating a score value representing a degree of similarity therebetween according to the comparison.

The processor module may be configured to then identify the integer charge value ([\hat{Q}ₗ]) achieving the highest said score value. Here, the threshold score value corresponds to the highest score value and the charge state (Q) of the ion is determined to be equal to the identified integer charge value ([\hat{Q}ₗ]) achieving the highest score value.

In some embodiments of the invention, the processor module is configured to calculate the plurality of different candidate CDMS image-charge/current signal frequency values (f_{Cand}ⁱ) to satisfy the following expression:

$${( \frac{α}{{f}_{C a n d}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k}{[ {Q}_{i} ] + n} )$$

As before, n is an integer selected to quantify a number of protonating protons bonded to the ion, mₚ is the mass of a proton and of the neutron (assumed to be equal), e is the charge of a proton, and α is a pre-set calibration constant. However, this expression now includes an additional incrementing integer k which is an integer selected to quantify a difference in a number of nuclear protons as between different isotopes or isotopologues of the ion. For example, the incrementing integer n may take any one or more of the values: n=0, ±1, ±2, ±3, ±4, ±5, . . . and the additional incrementing integer k may take any one or more of the values: k=0, ±1, ±2, ±3, ±4, ±5, . . . . Each different candidate CDMS image-charge/current signal frequency values (f_{Cand}ⁱ) corresponds to a different respective value of the integers n and k, for a given selected value of integer charge value ([Qᵢ]).

In some embodiments of the invention, the processor module is configured to calculate the plurality of different candidate CDMS image-charge/current signal frequency values (f_{Cand}ⁱ) to satisfy the following expression:

$${( \frac{α}{{f}_{C a n d}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k ∓ l}{[ {Q}_{i} ] + n} ) \pm ( \frac{{m}_{X}}{e} ) ( \frac{l}{[ {Q}_{i} ] + n} )$$

Once again, n is an integer selected to quantify a number of protonating protons bonded to the ion, mₚ is the mass of a proton, e is the charge of a proton, and α is a pre-set calibration constant. This expression includes the additional incrementing integer k which is the integer selected to quantify a difference in a number of nuclear protons as between different isotopes or isotopologues of the ion. However, this expression now includes a further incrementing integer l which is an integer selected to quantify a number of adduct ions of mass mₓ bonded to the ion. For example, the incrementing integer n may take any one or more of the values: n=0, ±1, ±2, ±3, ±4, ±5, . . . and the additional incrementing integer k may take any one or more of the values: k=0, ±1, ±2, ±3, ±4, ±5, . . . and the further incrementing integer l may take any one or more of the values: l=0, ±1, ±2, ±3, ±4, ±5, . . . Each different candidate CDMS image-charge/current signal frequency values (f_{Cand}ⁱ) corresponds to a different respective value of the integers n, k and l for a given selected value of integer charge value ([Qᵢ]).

In this way, the processor module may calculate the plurality of different candidate CDMS image-charge/current signal frequency values (f_{Cand}ⁱ) taking into account the following possible causes of differing masses and differing charges being bonded or adducted to the ion, thereby changing the number and position of spectral (frequency) components in the measured CDMS image-charge/current signal:
protons bonded to the ion (protonation);
isotopic variation in the mass of the ion;
adduct ions (e.g., Na⁺) bonded to the ion.

By selecting a measured signal frequency (f₀, FIG. 2a) common to a plurality of a measured CDMS image-charge/current signals, and by calculating a corresponding plurality 20 of estimated ion charge values Q according to the measured respective amplitudes of each one of the plurality of measured CDMS image-charge/current signals, the signal processing unit 12 may provide the raw data comprising data pairings (f, Q) of a signal frequency value of a CDMS image-charge/current signal component and an associated estimated/measured charge value. For example, as illustrated in FIG. 2a, nine separate signal frequency values (f=f₀, f₁, . . . , f₈) arise as distinct CDMS image-charge/current signal components and each has its own cluster of different estimated/measured ion charge values Q (e.g., the signal frequency component value f₀ has data cluster 20). The process of comparing the calculated plurality of different candidate CDMS image-charge/current signal frequency values (f_{Cand}ⁱ) to a plurality of different signal frequencies (f) of the measured CDMS image-charge/current signals may comprise calculating the difference values, Δ_{Cand}^{i,j}, of the differences between a given candidate frequency value and each one of the N distinct frequencies of signal components within the CDMS image-charge/current signal (e.g., N=9 in FIG. 2a):

$${Δ}_{C a n d}^{i , j} = \vert {f}_{j} - {f}_{C a n d}^{i} \vert , j = 0 , 1 , … N - 1$$

The processor module may be configured to calculate a degree of similarity between candidate frequencies (f_{Cand}ⁱ) and measured frequencies (fⱼ), amongst the plurality of a measured CDMS image-charge/current signals, as a sum (S_{Cand}ⁱ) of the number of candidate signal frequency values (f_{Cand}ⁱ) that differ from a signal frequency (fⱼ), by less than a predetermined threshold difference value (ε). For example, the processor module may simply count the number of candidate frequencies that satisfy the following condition:

$${Δ}_{Cand}^{i , j} = \vert {f}_{j} - {f}_{C a n d}^{i} \vert \leq ε , j = 0 , 1 , … N - 1$$

For example, the predetermined threshold difference value (ε) may be set by the user. It may be set to be substantially equal to the pre-determined, or pre-measured, ‘jitter’ or uncertainty in the measurements of the CDMS image-charge/current signal frequency components themselves. For example, referring to FIG. 2a, it can be seen that that each cluster of data pairs (f, Q) is concentrated at a respective one of nine discrete frequency values (fⱼ; j=0 to 8), but there exists a small spread of width ε in the values of the frequency within each cluster. This spread may be used to set the value of predetermined threshold difference value in the above equation. Applying this method allows one to determine a better estimate ([\hat{Q}ₗ]) of the true value of the ion charge by identifying the most appropriate one of the selected integer charge values ([Qᵢ]), namely the integer charge value [\hat{Q}ₗ] that achieves a score value that matches or exceeds a threshold score value (S_{Thresold}):

S_{Cand}ⁱ≥S_{Thresold}

Alternative scoring methods are possible, of course, and as an example of an alternative, the processor module may calculate the degree of similarity between the compared frequencies in terms of a score value, S_{Cand}ⁱ, given by:

$${S}_{Cand}^{i} = {\sum }_{j = 0}^{N - 1} \frac{1}{{Δ}_{Cand}^{i , j}}$$

This score value is inversely proportional to the sum of frequency differences. A given difference value Δ_{Cand}^{i,j} will be large if the difference between a candidate frequency, f_{Cand}ⁱ, and a measured frequency, fⱼ, is large (i.e., if they are not similar), but it will be large if there is a close similarity between a candidate frequency, f_{Cand}ⁱ, and a given one of the measured frequencies, fⱼ. Thus, the greater the number of close matches between the compared frequencies, the greater will be the score value. The processor module may be configured to calculate the degree of similarity to comprise a sum of the differences between each calculated candidate CDMS image-charge/current signal frequency value (f_{Cand}ⁱ) and a signal frequency nearest thereto from amongst the plurality of a measured CDMS image-charge/current signals. For example, optionally, only if Δ_{Cand}^{i,j} is less than a pre-set maximum value will the difference be included in the calculation:

$${S}_{Cand}^{i} = {\sum }_{j = 0}^{N - 1} \frac{1}{{Δ}_{Cand}^{i , j}}$$

For example, the pre-set maximum value may be equal to a frequency separation between two neighbouring measured frequency components of the overall CDMS image-charge/current signal (e.g., the closest two components within the overall CDMS image-charge/current signal). This aims to avoid inclusion from the calculation of the score value of frequency components of the CDMS image-charge/current signal that are very dissimilar to a candidate frequency value.

The score value may be calculated in any weighted manner with respect to frequency difference, such that the smaller the value of Δ_{Cand}^{i,j} the larger the value of an associated weight Wⱼ such that:

$${S}_{Cand}^{i} = {\sum }_{j = 0}^{N - 1} {W}_{j} {Δ}_{Cand}^{i , j}$$

For distant fj values, the value of Wⱼ tends to zero (and is never negative). For instance, weight function Wⱼ, may be:

$${W}_{j} = a \cdot exp [ - {b ( {Δ}_{Cand}^{i , j} )}^{2} ]$$

Here a and b are constants (e.g., a=1, b=1). This may further improve the quality of the method as it will emphasize values of [Q] at which there exist a greater number of closer signal frequencies rather than distant frequencies.

As described above, the processor module may be configured to calculate a plurality of different candidate CDMS image-charge/current signal frequency values (f_{Cand}ⁱ) by a process comprising selecting a plurality of different candidate states of ion isotope or isotopologue by selecting a plurality of different values for the additional integer k, and/or a plurality of different candidate states of ion protonation by selecting a plurality of different values for the integer n, and/or a plurality of different candidate states of adduct ion by selecting a plurality of different values for the further integer l. Each of these different values of frequency may correspond to a common fixed candidate state of ion protonation, or isotope or isotopologue or adduct ion (i.e., the same fixed value of n, or k or l), or some but not all may correspond to a common candidate state of ion protonation, or isotope or isotopologue, or adduct ion (i.e., the same value of n, k or l), or some or all may correspond to a different candidate states of ion protonation, or isotope or isotopologue, or adduct ion (i.e., different values of n, k or l).

For example, the processor module may calculate the plurality of different candidate CDMS image-charge/current signal frequency values (f_{Cand}ⁱ) by a process comprising selecting a plurality of different candidate states of ion protonation (n) and/or adduct ions (l) each of which shares a common fixed candidate state of ion isotope or isotopologue (k). Alternatively, the processor module may calculate said plurality of different candidate CDMS image-charge/current signal frequency values (f_{Cand}ⁱ) by a process comprising selecting different candidate states of ion protonation (n) and/or adduct ions (l) and simultaneously different candidate states of ion isotope or isotopologue (k). Other combinations and variations of integers n, k or l are possible, according to the desire of the user.

Once the integer charge value ([\hat{Q}ₗ]) achieving the highest said score value has been identified by the scoring process, the processor module may calculate a mass value (M) for the ion undergoing oscillatory motion at selected measured signal frequency (f₀), by using the identified integer charge value ([\hat{Q}ₗ]) according to the relation:

$$M = [ \hat{{Q}_{ι}} ] {( \frac{α}{{f}_{0}} )}^{2}$$

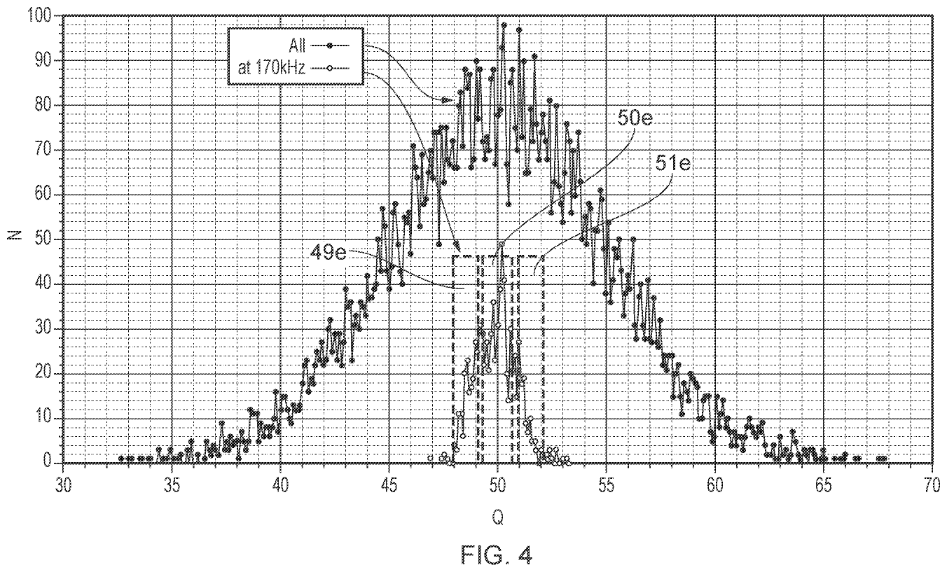

By repeating this process for a plurality of different measured signal frequencies (e.g., f=f₀, f₂, . . . , f₈), one may generate a mass spectrum such as, for example, discussed below in more detail with reference to FIGS. 4 to 7b.

FIG. 2b shows a flow chart of steps in a process for determining an integer charge value for an ion undergoing oscillatory motion of a given frequency selected from the different signal frequency values and the corresponding plurality of differing estimated charge values [Q] of FIG. 2a. The method is applicable to processing a data set of data determined from an image-charge/current signal representative of ions of a given charge state (Q) undergoing oscillatory motion of a respective oscillation frequency (f) within an ion analyser apparatus. The method, in an embodiment of the invention, comprises the following steps:
Step S1: Obtain the data set;
Step S2: Generate a plurality of integer charge values ([Q]) each corresponding to a respective estimated ion charge value rounded to the nearest integer value;
Step S3: Select an integer charge value ([Qᵢ]) and therewith calculate a plurality of different candidate CDMS image-charge/current signal frequency values (f_{Cand}ⁱ) according to the selected measured signal frequency (f₀) and according to a corresponding one of one or more different candidate charge states of the ion (e.g., protonation (n) and/or adduct ions (l)) and/or of ion isotope or isotopologue (k);
Step S4: Compare the calculated plurality of different candidate CDMS image-charge/current signal frequency values (f_{Cand}ⁱ) to a plurality of different signal frequencies (f) of the measured CDMS image-charge/current signals;
Step S5: Calculate a score value according to the comparison at Step 4, representing a degree of similarity between candidate signal frequencies and measured signal frequencies;
Step S5B: Repeat steps S3, S4 and S5 in respect of each integer charge value ([Qᵢ]) amongst said generated integer charge values ([Q]);
Step S6: Identify the integer charge value ([\hat{Q}ᵢ]) achieving the highest said score value;
Step S7: Determine the charge state (Q) of the ion undergoing oscillatory motion of the selected measured signal frequency (f₀), to be equal to the integer charge value ([\hat{Q}ᵢ]) achieving the highest score value.

### EXAMPLES

### Example 1

The amplitudes of all detected frequency components in a CDMS experiment were measured and converted into charge values. In so doing a data set, or list, of frequency and charge value pairs (fᵢ, Q) was obtained. Each measured frequency fᵢ from the list was then considered in turn. In particular, its associated measured charge value Q was processed according to the scoring technique described above. Since the true charge value charge must be integer (in electron charge units), the measured charge value Q was rounded to the nearest integer, i.e., Q→[Q ], where [Q ] is an integer. It was assumed that our ion of oscillatory frequency f₀ (and corresponding mass-to-charge ratio (m/z)) could potentially bear a charge selected from: [Q]−2,; [Q]−1; [Q]; [Q]+1; [Q]+2. For example, our ion's mass-to-charge ratio may be (m/z)=800 Th, with a measured charge, after integer rounding, of [Q]=50e. This means that we may infer a mass of M=800Th*50e−50mₚ=39950 Da. The number of such guessed values may be chosen according to the background CDMS image-charge/current signal noise level. Note, that the background noise level is determined by electrical circuit components and temperature and also by the lifetime (LT) of the ion. The smaller the LT the higher the noise level and vice versa. We calculated a score for each guessed charge [Q] and choose charge achieving the highest score. For instance, our score was maximal for [Q]−1=49e. Given that (m/z)=800Th (this is not changed) and best estimated charge value of 49e, the mass of the molecule may be estimated to be: M=800Th*49e−49mₚ=39151 Da. Here, we have subtracted ([Q]−1) mₚ to arrive at an estimate of the molecule mass (no protons attached). This mass is assumed to be a correct one, or at least an improved estimate, whereas 39950 Da is assumed to be incorrect.

Calculation of a score for each one of five different candidate integer charge values: [Q]−2,; [Q]−1; [Q]; [Q]+1; [Q]+2 proceeded as follows. Because CDMS image-charge/current measurements comprise concurrent data for a huge number of ions coming from an analyte, the data will correspond to lots of different combinations of isotopologues (dictated by isotopical composition and isotopic abundances) and charge states (dictated by molecule shape and structure and by ionisation conditions). This means we are bound to see the same molecule type (the one which corresponds to our frequency f₀) having other charge states and other isotopic composition. We decide a number of rules we are going to check. For example, we checked frequency positions for signal frequency components corresponding to +/−1 charge states and +/−5 mₚ (isotopologues) and their mixture +/−5 mₚ at 1e larger charge state, summarised as follows:
(1) 1 proton lower charge state: n=−1
(2) 1 proton higher charge state: n=1
(3) 5mₚ lower mass (same charge state: n=0): k=−5
(4) 5mₚ higher mass (same charge state: n=0): k=5
(5) 1 proton higher charge state +5mₚ higher mass: n=1, k=5
(6) 1 proton higher charge state −5mₚ lower mass: n=1, k=−5

There are 6 rules in total. We proposed a first candidate integer charge value [Q]=48e and this immediately defined our guessed molecule's mass as:

$$M = ( e \times {( \frac{m}{z} )}_{n , k = 0} - {m}_{p} ) [ Q ] = 800 Th * 48 e - 48 Da = 38352 Da$$

In the above equation, the quantity [0]mₚ is subtracted to arrive at an estimate of the molecule mass (no protons attached). We checked all other frequencies f_{n,k} (and equivalent (m/z)) corresponding to the different selected values of n and k, calculated by means of formula:

$$( \frac{m}{z} ) = {( \frac{α}{f} )}_{n , k}^{2} = ( \frac{{M}_{0} + ( [ Q ] + n + k ) {m}_{p}}{( [ Q ] + n ) e} ) = {( \frac{α}{{f}_{0}} )}^{2} ( \frac{[ Q ]}{[ Q ] + n} ) + ( \frac{{m}_{p}}{e} ) ( \frac{n + k}{[ Q ] + n} )$$

Thus, we have 6 frequencies f_{n,k}, and we compared these against all of the frequencies fᵢ, in our dataset of frequency and charge value pairs (fᵢ, Q) and checked whether any of them coincide with fᵢ, (or were sufficiently close). If for each we that found to coincide (or was sufficiently close) we incremented the score value by one (i.e., an integer score). After we checked all frequencies fᵢ from the dataset, with fᵢ in place of f₀ in the above expression, we achieved a score value for each frequency.

Next, we incremented the candidate integer charge to be [Q]=49e and repeated the above process. We repeated the process again for each one of the five different candidate integer charge values: [Q]−2,; [Q]−1; [Q]; [Q]+1; [Q]+2. In this manner we obtained five scores (one for each candidate integer charge) and we found that the score for [Q]=[\hat{Q}]=49e was maximal. This charge was accepted as more accurate charge estimate in place of the initial 50e for the ion with oscillatory frequency f₀.

Then, we considered the next frequency fᵢ, in our dataset of frequency and charge value pairs (fᵢ, Q) in our dataset and repeat the above-described procedure. That is, in the end of the process, our frequency values from the initial dataset (fᵢ, Q) are transformed into (fᵢ, [\hat{Q}ᵢ]) where the frequency values (and consequently m/z values) are not changed, whereas the Q values are improved: i.e., Q→[\hat{Q}ᵢ]. The corresponding mass spectrum was then obtained from the frequency spectrum of the data (i.e., the fᵢvalues) via the relationship:

$${M}_{i} = [ \hat{{Q}_{ι}} ] {( \frac{α}{{f}_{i}} )}^{2} - [ \hat{{Q}_{ι}} ] {m}_{p}$$

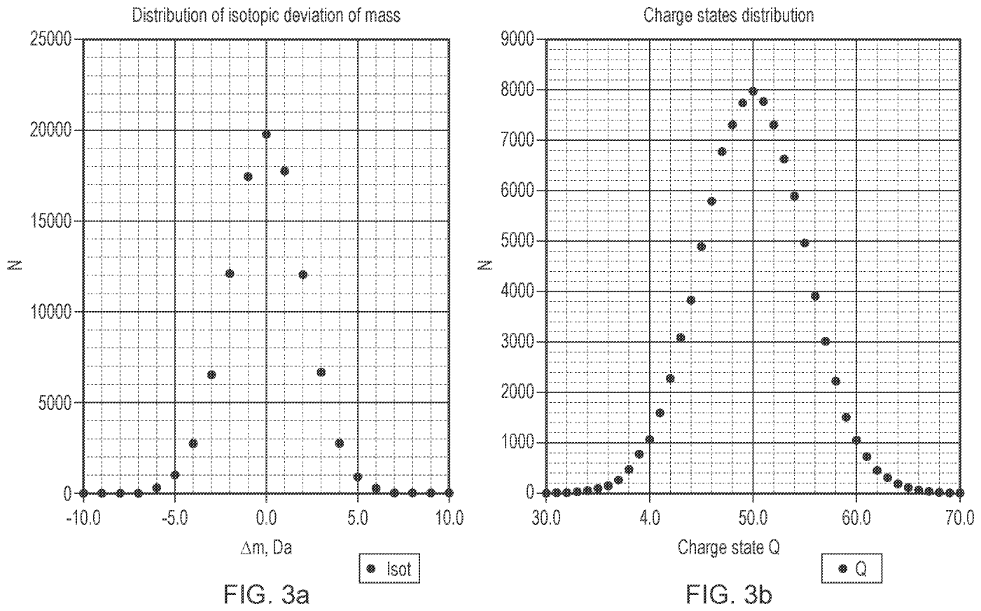

The mass spectrum is the spectrum of the mass of molecules, i.e. we have subtracted the quantity [\hat{Q}ᵢ]mₚ(provided there is only H⁺ attached, no other cations). FIGS. 3, 4 and 5a, 5b and 5c illustrates the conditions used to obtain a synthetic mass spectrum. The spectrum was simulated using a most probable molecular mass of M₀=40000.00 Da with a number of protons (mₚ=1 Da) attached according to the charge state and isotopic difference between isotopologues to be according to the neutron mass: mₙ=1 Da A randomly distributed value r_{Q} with Standard Deviation of +1e was added to the charge state value to simulate measured (detected) charge. That is, ten thousand (i.e., 10⁴) detected ions were used in the dataset. Each ion's mass and charge were generated as follows:
Isotopic difference Δmᵢₛₒₜ was added to the mass M₀ according to the probability distribution showed in FIG. 3a.
Charge (number of attached protons) Q₀ was attributed according to the probability distribution showed in FIG. 3b.
Frequency value was calculated according to:

$$f = α {( \frac{{M}_{0} + Δ {m}_{iso𝔱}}{{Q}_{0}} )}^{- 1 / 2}$$

Here, the calibration coefficient α=4830.245.
Measured frequency fₘ was generated by adding a random number r_{f} (distributed with uniform distribution within the range: +/−0.5 Hz) to the frequency fₘ=f+r_{f}. This feature is attributed to the various instrumental errors which result in frequency jitter.
Measured m/z was then re-calculated using:

$$( m / z ) = {( \frac{α}{{f}_{i}} )}^{2}$$

Measured Q was generated using random number r_{Q} as follows: Q=Q₀+r_{Q}.
After application of the scoring method described herein, the data pairings (fₘ, [\hat{Q}ᵢ]) were recorded into an output datafile.

We simulated a protein mass of 40 kDa which have a range of isotopologues with Gaussian distribution around most probable mass of 40 kDa, and a range of possible charge states with Gaussian distribution as well around most probable charge of 50e. The Standard deviations (SD) for these distributions are 2 mₚ (or 2 Da)) and 5e, respectively. FIGS. 3a and 3b demonstrate what ranges of mass deviation and charge states are involved in the example. Detected (simulated detection) charge will therefore have uncertainty of 1e (Gaussian distribution as well, SD=1e). FIG. 4 shows the distribution of generated charges Q and distribution of isolated 50e charge state ions (corresponding to 50e ions revealing oscillation frequencies around 170.67 kHz). Finally, measured frequency had a jitter of +/−0.1 Hz (uniformly distributed). The total number of points in the dataset is 10000.

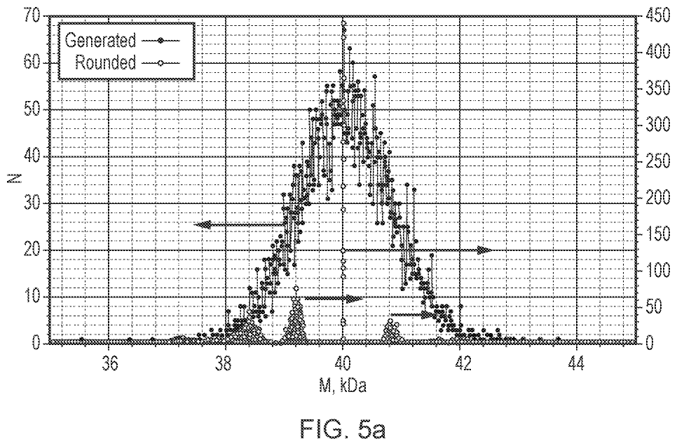

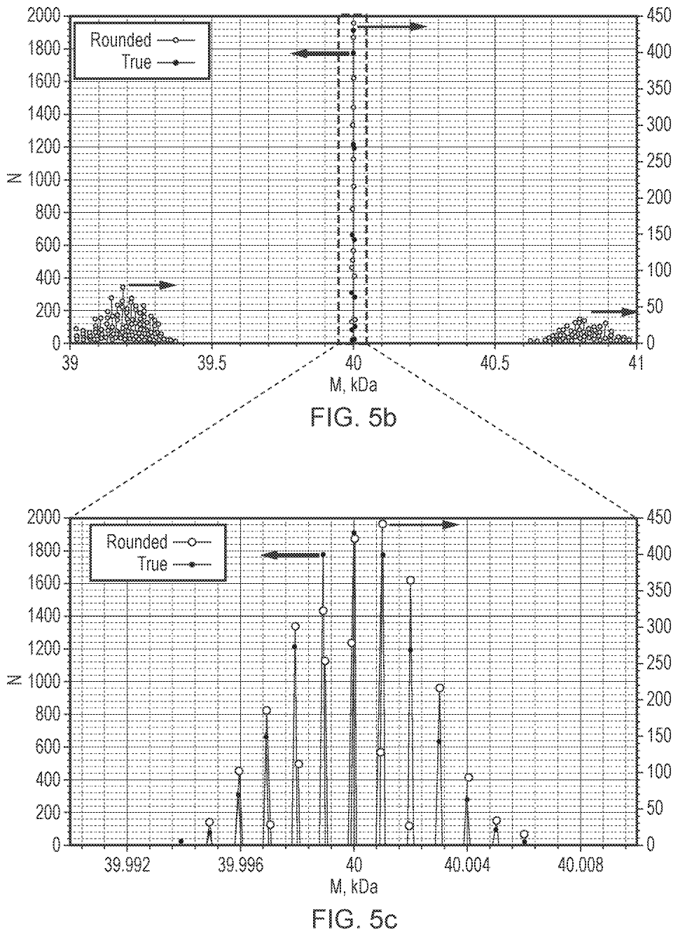

FIGS. 5a, 5b and 5c show plots following histograms as follows.

In FIG. 5a, the data generated as described above is shown by the upper line, read from the left-hand vertical axis, in which mass values M are obtained according to measured charge Q and the measured m/z as: M=m/z*Q. This mass histogram is very wide due to poor charge measurement accuracy, no isotopologues can be resolved. The data generated as described above after the measured charge Q is rounded to its nearest integer value [Q] is shown by the lower line, read from the right-hand vertical axis, The mass values were obtained in this graph according to rounded charges: M=m/z*[Q]−[Q]*mₚ. This histogram shows isotopologues resolved but only for those charges which after rounding coincided with the actual charge on an ion. All others resulted in mass error which is m/z*1e=ca. 800 Da. These peaks are erroneous and cannot be distinguished from the true peaks in a real experiment. Therefore, rounding alone does improve mass histogram, but it is still not suitable for high-accuracy mass spectrometry.

FIGS. 5b and 5c show the mass spectrum corresponding to the actual mass of of a protein (i.e., mass reduced by removing the masses of all protonating protons) in the form: M=M₀+Δmᵢₛₒₜ. FIG. 5b is an exploded view of a part of FIG. 5a with the data corresponding to the generated mass values M omitted, and only the rounded integer charge values [Q] shown. FIG. 5c is an exploded view of FIG. 5b.

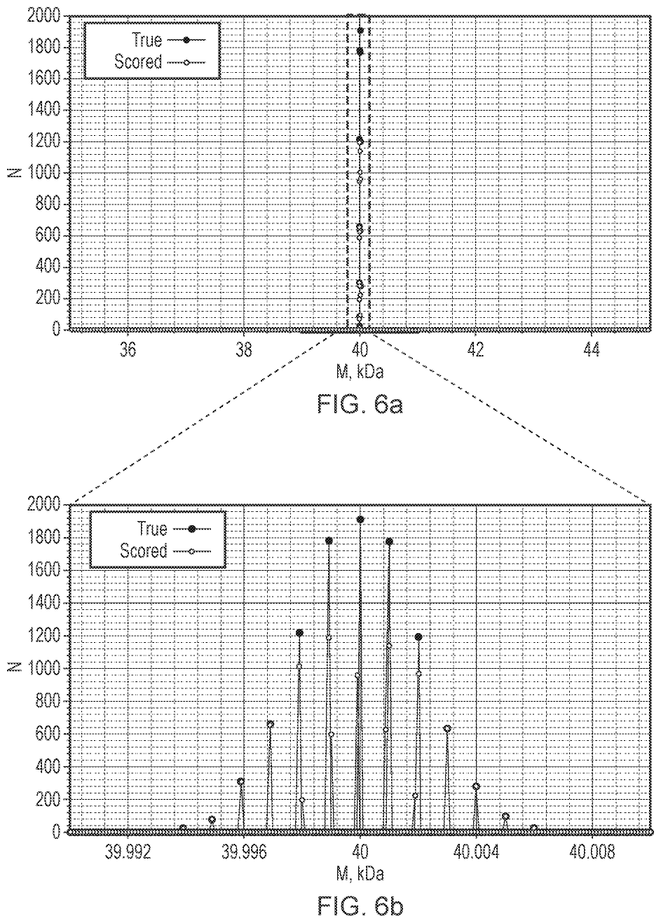

FIGS. 6a and 6b show a mass histogram where mass was obtained after new charges [\hat{Q}ᵢ] were generated using the scoring algorithm. FIGS. 6b shows an exploded view of a part of FIGS. 6a. Wider peaks are due to frequency jitter, area under red peaks is conserved compared to the area under the black peaks. The data marked “scored” in FIGS. 6a and 6b show a mass spectrum obtained from the initial dataset (which has the ‘generated’ mass spectrum is shown in FIG. 5a) after the scoring algorithm was applied, data marked as “true” represents the true mass distribution. It is seen that there are no spurious peaks and number of detected points (area under mass histogram) is equal to the number of masses used in simulation (area under “true” curve). Here, we calculated a degree of similarity between candidate frequencies (f_{Cand}ⁱ) and measured frequencies (fⱼ), amongst the plurality of measured CDMS image-charge/current signals, as a sum ('score'=S_{Cand}ⁱ) of the number of candidate signal frequency values (f_{Cand}ⁱ) that differ from a signal frequency (fⱼ ), by less than a predetermined threshold difference value (ε). Here, ε=0.5 Hz, and a scoring threshold=4 is used whereby a ‘best score’ must exceed a value of 4. Below is an example of scores for 3 considered frequencies.

Freq=161.921602000 [KHz]:
Assumed [Q]=41: Score=0
Assumed [Q]=42: Score=0
Assumed [Q]=43: Score=0
Assumed [Q]=44: Score=0
Assumed [Q]=45: Score=213
Assumed [Q]=46: Score=0
Assumed [Q]=47: Score=0
Best [Q]=[\hat{Q}]=45: Score=213

Freq=180.610672000 [KHz]:
Assumed [Q]=52: Score=0
Assumed [Q]=53: Score=0
Assumed [Q]=54: Score=0
Assumed [Q]=55: Score=0
Assumed [Q]=56: Score=161
Assumed [Q]=57: Score=0
Assumed [Q]=58: Score=0
Best [Q]=[\hat{Q}]=56: Score=161

Freq=161.919572000 [KHz]:
Assumed [Q]=42: Score=0
Assumed [Q]=43: Score=0
Assumed [Q]=44: Score=0
Assumed [Q]=45: Score=242
Assumed [Q]=46: Score=0
Assumed [Q]=47: Score=0
Assumed [Q]=48: Score=0
Best [Q]=[\hat{Q}]=45: Score=242

Losses/adducts as parts of a mass spectrum

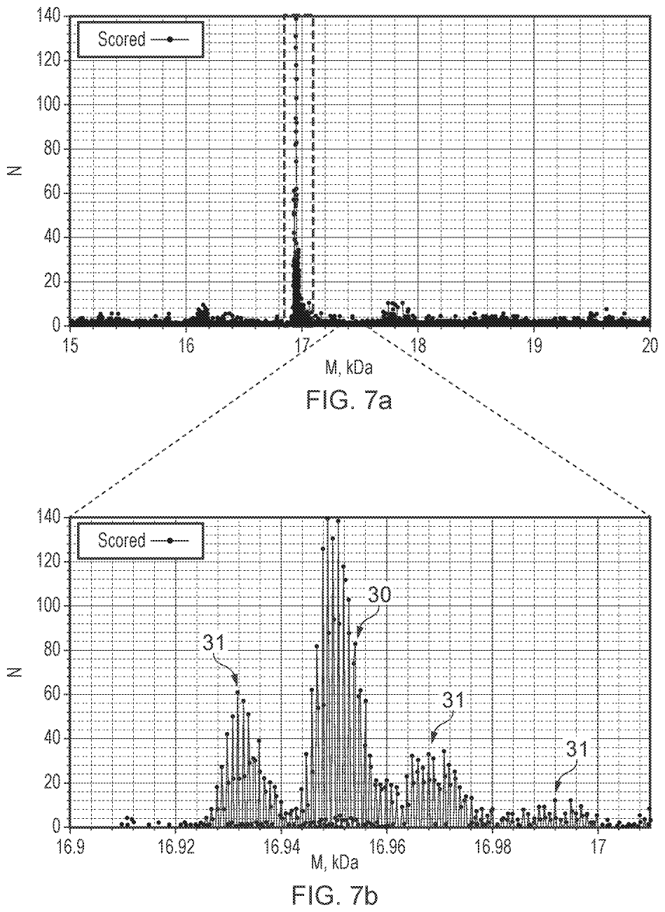

FIGS. 7a and 7b show mass histograms of Myoglobin (protein mass 17 kDa) obtained after measured charge values Q were improved by means of the scoring algorithm disclosed herein.

These are real experiment data. The mass histogram consists of the main envelope 30 believed to correspond to the most probable protein mass, and three satellite envelopes 31. These satellite envelopes are believed to correspond to water loss, sodium adducts in the form of a cation Na⁺, water adducts and potassium adducts in the form of a cation K⁺. The histogram reveals such envelopes even though Na⁺and K⁺were not considered in the scoring algorithm when the data were processed. This is because if there are peaks caused by Na⁺, they will appear on all charge states and during scoring based on following m/z positions:

$$( \frac{m}{z} ) = ( \frac{{M}_{0} + ( [ Q ] + n + k ) {m}_{p}}{( [ Q ] + n ) e} )$$

The positions are achieved by varying n and k values. This will cause (m/z) values to fall into points corresponding to m_{Na}−Mₚ=22 Dan in respect of sodium adducts in the form of a cation Na⁺, where we will find sodiated peaks (NB. sodiated envelopes will appear on all charge states) which will contribute into the score value. The same considerations are in place for water loss, water adduct and potassium adduct. It may be suitable to consider things like sodium cation adduct, or other adducts, during the scoring process. For example, the scoring process in this case may instead be based on following m/z positions to account for this:

$$( \frac{m}{z} ) = ( \frac{{M}_{0} + ( [ Q ] + ( n - 1 + k ) {m}_{p} + {m}_{x}}{( [ Q ] + n ) e} )$$

Here, mₓ is the mass of the cation Na⁺, or the water adduct or the cation K⁺. Below is an example of scores for four candidate frequencies. Here, we calculated a degree of similarity between candidate frequencies (f_{Cand}ⁱ) and measured frequencies (fⱼ), amongst the plurality of measured CDMS image-charge/current signals, as a sum ('score'=S_{Cand}ⁱ) of the number of candidate signal frequency values (f_{Cand}ⁱ) that differ from a signal frequency (fⱼ), by less than a predetermined threshold difference value (ε). Here, ε=0.5 Hz, and a scoring threshold=4 is used whereby a ‘best score’ must exceed a value of 4, and charge range of +/−3e is applied:

f_{Cand}ⁱ=157.307912900 [KHz]:
Assumed [Q]=16: Score=2
Assumed [Q]=17: Score=6
Assumed [Q]=18: Score=45
Assumed [Q]=19: Score=6
Assumed [Q]=20: Score=8
Assumed [Q]=21: Score=2
Assumed [Q]=22: Score=5
Assumed [Q]=23: Score=0
Assumed [Q]=24: Score=2
Assumed [Q]=25: Score=4
Assumed [Q]=26: Score=7
Best [\hat{Q}]=18: Score=45
ACCEPTED: NewQ=[\hat{Q}]=18, New Mass=16971.22218

f_{Cand}ⁱ=161.647224000 [KHz]:
Assumed [Q]=16: Score=4
Assumed [Q]=17: Score=2
Assumed [Q]=18: Score=10
Assumed [Q]=19: Score=51
Assumed [Q]=20: Score=8
Assumed [Q]=21: Score=5
Assumed [Q]=22: Score=3
Assumed [Q]=23: Score=7
Assumed [Q]=24: Score=2
Assumed [Q]=25: Score=6
Assumed [Q]=26: Score=8
Best [\hat{Q}]=19: Score=51
ACCEPTED NewQ=[\hat{Q}]=19, New Mass=16965.19485

f_{Cand}ⁱ=165.871058500 [KHz]:
Assumed [Q]=16: Score=5
Assumed [Q]=17: Score=7
Assumed [Q]=18: Score=11
Assumed [Q]=19: Score=11
Assumed [Q]=20: Score=12
Assumed [Q]=21: Score=4
Assumed [Q]=22: Score=4
Assumed [Q]=23: Score=6
Assumed [Q]=24: Score=5
Assumed [Q]=25: Score=8
Assumed [Q]=26: Score=2
Best [\hat{Q}]=20: Score=12
ACCEPTED: NewQ=[\hat{Q}]=20, New Mass=16960.18229

f_{Cand}ⁱ=169.912148600 [KHz]:
Assumed [Q]=16: Score=23
Assumed [Q]=17: Score=7
Assumed [Q]=18: Score=7
Assumed [Q]=19: Score=8
Assumed [Q]=20: Score=25
Assumed [Q]=21: Score=177
Assumed [Q]=22: Score=13
Assumed [Q]=23: Score=4
Assumed [Q]=24: Score=5
Assumed [Q]=25: Score=5
Assumed [Q]=26: Score=5
Best [\hat{Q}]=21: Score=177
ACCEPTED: NewQ=[\hat{Q}]=21, New Mass=16971.18562

The advantage of the scoring approach disclosed herein, as compared to simple charge averaging methods, is that we do not need to know what molecules we are working with and what charge state is to be assigned to points situated near a certain frequency. Present method is a more general method not a targeted one as in the charge averaging method. It is applicable to proteins, antibodies, viruses and any biological molecules able to carry multiple charges. This approach is also suitable for multiply charged molecules in which large signal noise does not allow accurate measurements of small charge states.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations. Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.
W. Shockley: “Currents to Conductors Induced by a Moving Point Charge”, Journal of Applied Physics 9, 635 (1938)]
S. Ramo: “Currents Induced by Electron Motion”, Proceedings of the IRE, Volume 27, Issue 9, September 1939
WO2012/116765 (A1) (Ding et al.)

1. A method of processing data determined from an image-charge/current signal representative of ions of a given charge state (Q) undergoing oscillatory motion of a respective oscillation frequency (f) within an ion analyser apparatus, the method comprising:
acquiring a data set comprising a measured signal frequency (f₀) common to a plurality of a measured image-charge/current signals and a plurality of estimated ion charge values corresponding to respective amplitudes of each one of said plurality of measured image-charge/current signals;
generating an integer charge value ([Q]) corresponding to a said estimated ion charge value rounded to the nearest integer value; and,
(a) selecting said integer charge value ([Qᵢ]) and therewith calculating a plurality of different candidate image-charge/current signal frequency values (f_{Cand}ⁱ) according to said selected measured signal frequency (f₀) and according to a corresponding one of one or more different candidate charge states of the ion and/or of ion isotope or isotopologue; then,
(b) comparing the calculated plurality of different candidate image-charge/current signal frequency values (f_{Cand}ⁱ) to a plurality of different signal frequencies (f) of the measured image-charge/current signals and calculating a score value representing a degree of similarity therebetween according to the comparison;
determining the charge state (Q) of the ion undergoing oscillatory motion of said selected measured signal frequency (f₀), to be equal to the integer charge value ([\hat{Q}ᵢ]) if said score value matches or exceeds a threshold score value.

2. A method according to claim 1 wherein said step of generating an integer charge value ([Q]) comprises generating a plurality of integer charge values ([Q]) each corresponding to a respective said estimated ion charge value rounded to the nearest integer value; and,
(c) repeating step (a) and step (b) in respect of each said integer charge value ([Qᵢ]) amongst said generated integer charge values ([Q]); then,
(d) identifying the integer charge value ([\hat{Q}l]) achieving the highest said score value;
wherein said threshold score value corresponds to the highest said score value and said charge state (Q) of the ion is determined to be equal to the identified integer charge value ([\hat{Q}l]) achieving the highest said score value.

3. A method according to claim 1 wherein the calculating of a plurality of different candidate image-charge/current signal frequency values (f_{Cand}ⁱ) is performed to satisfy the following condition:
$${( \frac{α}{{f}_{Cand}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k}{[ {Q}_{i} ] + n} )$$
where n is an integer selected to quantify a number of protonating protons bonded to the ion, k is an integer selected to quantify a difference in a number of nuclear neutrons as between different isotopes or isotopologues of the ion, mₚ is the mass of a proton, e is the charge of a proton, and α is a pre-set calibration constant.

4. A method according to claim 1 wherein the calculating of a plurality of different candidate image-charge/current signal frequency values (f_{Cand}ⁱ) is performed to satisfy the following condition:
$${( \frac{α}{{f}_{Cand}^{i}} )}^{2} ∝ {( \frac{α}{{f}_{0}} )}^{2} ( \frac{[ {Q}_{i} ]}{[ {Q}_{i} ] + n} ) + ( \frac{{m}_{p}}{e} ) ( \frac{n + k ∓ l}{[ {Q}_{i} ] + n} ) \pm ( \frac{{m}_{X}}{e} ) ( \frac{l}{[ {Q}_{i} ] + n} )$$
where l is an integer selected to quantify a number of adduct ions of mass m_{X} bonded to the ion, n is an integer selected to quantify a number of protonating protons bonded to the ion, k is an integer selected to quantify a difference in a number of nuclear neutrons as between different isotopes or isotopologues of the ion, mₚ is the mass of a proton, e is the charge of a proton, and α is a pre-set calibration constant.

5. A method according to claim 1 wherein said acquiring a data set comprises:
selecting a measured signal frequency (f₀) common to said plurality of a measured image-charge/current signals; and,
calculating said plurality of estimated ion charge values according to the measured respective amplitudes of each one of said plurality of measured image-charge/current signals.

6. A method according to claims 1 wherein said degree of similarity comprises a sum of the number of calculated candidate image-charge/current signal frequency values (f_{Cand}ⁱ) that differ from a signal frequency amongst said plurality of a measured image-charge/current signals, by less than a predetermined threshold difference value.

7. A method according to any preceding claim 1 wherein said calculating a plurality of different candidate image-charge/current signal frequency values (f_{Cand}ⁱ) comprises selecting a plurality of different candidate states of ion isotope or isotopologue (k) each of which shares a common fixed candidate state of ion protonation (n).

8. A method according to claim 1 wherein said calculating a plurality of different candidate image-charge/current signal frequency values (f_{Cand}ⁱ) comprises selecting a plurality of different candidate states of ion protonation (n) each of which shares a common fixed candidate state of ion isotope or isotopologue (k).

9. A method according to claim 1 wherein said calculating a plurality of different candidate image-charge/current signal frequency values (f_{Cand}ⁱ) comprises selecting different candidate states of ion protonation (n) and simultaneously different candidate states of ion isotope or isotopologue (k).

10. A method according to claim 1 comprising determining a mass value (M) for the ion undergoing oscillatory motion of said selected measured signal frequency (f₀), according to the identified integer charge value ([\hat{Q}ᵢ]) achieving the highest said score value and according to the relation:
$$M ∝ [ \hat{{Q}_{ι}} ] {( \frac{α}{{f}_{0}} )}^{2}$$

11. An apparatus configured to processing data determined from an image-charge/current signal representative of ions of a given charge state (Q) undergoing oscillatory motion of a respective oscillation frequency (f) within an ion analyser apparatus, comprising a processor module configured to:
acquire a data set comprising a measured signal frequency (f₀) common to a plurality of a measured image-charge/current signals and a plurality of estimated ion charge values corresponding to respective amplitudes of each one of said plurality of measured image-charge/current signals;
generate an integer charge value ([Q]) each corresponding to a said estimated ion charge value rounded to the nearest integer value; and,
(a) select said integer charge value ([Qᵢ]) and therewith calculate a plurality of different candidate image-charge/current signal frequency values (f_{Cand}ⁱ) according to said selected measured signal frequency (f₀) and according to a corresponding one of one or more different candidate charge states of the ion and/or of ion isotope or isotopologue; then,
(b) compare the calculated plurality of different candidate image-charge/current signal frequency values (f_{Cand}ⁱ) to a plurality of different signal frequencies (f) of the measured image-charge/current signals and calculate a score value representing a degree of similarity therebetween according to the comparison;
determine the charge state (Q) of the ion undergoing oscillatory motion of said selected measured signal frequency (f₀), to be equal to the identified integer charge value ([\hat{Q}ₗ]) if said score value matches or exceeds a threshold score value.

12. An apparatus according to claim 11 wherein the processor module is configured to generate an integer charge value ([Q]) by generating a plurality of integer charge values ([Q]) each corresponding to a respective said estimated ion charge value rounded to the nearest integer value; and,
(c) repeat step (a) and step (b) in respect of each said integer charge value ([\hat{Q}ᵢ]) amongst said generated integer charge values ([Q]); then,
(d) identify the integer charge value ([\hat{Q}ᵢ]) achieving the highest said score value;
wherein said threshold score value corresponds to the highest said score value and said charge state (Q) of the ion is determined to be equal to the identified integer charge value ([\hat{Q}ₗ]) achieving the highest said score value.

13. An ion analyser comprising the apparatus according to claims 11.

14. A computer program or a computer program product adapted to perform the method according to claim 1.

15. A computer-readable storage medium or data carrier comprising the computer program or computer program product according to claim 14.
